(19) United States
(12) Patent Application Publication
(10) Pub. No.: US 2013/0188943 A1
(43) Pub. Date: Jul. 25, 2013

(54) Camera Adapter

(71) Applicant: Shing-Wai David Wu, Kowloon (CN)

(72) Inventor: Shing-Wai David Wu, Kowloon (CN)

(21) Appl. No.: 13/353,680

(22) Filed: Jan. 19, 2012

(51) Int. Cl. G03B 17/00; G03B 11/00

(52) U.S. Cl. 396/419; 396/544

(57) ABSTRACT

An adapter is provided for a camera having an image display screen at one side and a lens at another side. A magnet attaches the body of the adapter to the camera and mirrors inside the body reflect light into the lens from a subject viewing the image display screen directly.

### BACKGROUND OF THE INVENTION

The present invention relates to photography. The invention more particularly, although not exclusively, relates to an adapter for improving the photographic functionality of a camera such as that built into a mobile telephone like the Apple iPhone®.

Some mobile telephones like the Apple iPhone® have a front-facing camera lens (and associated CCD) at the same face as the screen and a rear-facing camera lens (and associated CCD) of better quality. The front-facing lens is intended for taking self-portraits whereby the user holds the phone at arm's length and the screen can be seen to assist in “framing” the photograph. A higher resolution self-portrait can be taken using the rear-facing lens. The phone is again held at arm's length but turned around, however the user cannot see the screen to “frame” the photograph.

Another problem with such phones arises when taking group photographs. If an outsider is not available, then one party of the group usually holds the phone to take the group photograph. Of course that party cannot be in the photograph. If the phone is set to take a timed photograph of the group, then the group could only “frame” themselves using the phone's screen if the low quality front-facing camera is deployed.

Of course all of the above applies to any single lens digital camera having the lens at the face opposite to that at which the display screen is located.

### SUMMARY

There is disclosed herein an adapter for a camera having an image display screen at one side thereof and a lens at another side thereof, the adapter comprising:

a body;

attachment means for attaching the body to the camera;

optical means supported by the body to reflect and/or refract light into the lens from a subject viewing the image display screen directly.

Preferably, said optical means comprises:

a first optical means to align with the camera lens when the body is so attached; and

a second optical means aligning with the subject and cooperating with the first optical means.

Preferably, the first and second optical means comprise mirrors cooperating with one another to reflect light from the subject throughout 180° to the camera lens.

Preferably, the mirrors are mutually offset by 90°.

Preferably, the adapter further comprises a top lens through which light from the subject must pass en route to the mirrors.

Preferably, the body further comprising a magnetic or metallic ring around the top lens to magnetically secure an auxiliary lens such as a fisheye lens.

Preferably, the attachment means for attaching the body to the camera comprises:

a magnetic or metallic anchor at the body;

a casing to receive a portion of a camera, the casing comprising an aperture to align with the camera lens, and a metallic or magnetic attractant to which the anchor attaches magnetically to maintain said alignment.

Preferably, the casing comprises an internal thread by which the casing might be supported by a tripod.

Preferably, the internal thread is metallic and the adapter further comprises a base to support the casing on a surface, the base having an embedded magnet to attract the internal thread without the need for threaded engagement between the base and casing.

Preferably, the casing comprises an electrical plug that is received by a jack of the camera when the casing receives a portion of the camera, the casing housing an infrared or RF receiver to receive remotely controlled camera activation signals passed to the camera via the plug.

There is further disclosed herein a camera support, comprising:

a casing to receive a portion of a camera, the casing comprises an electrical plug that is received by a socket of the camera; and
an infrared or RF receiver to receive remotely controlled trigger signals to control the camera via the plug.

Preferably, the camera support further comprises a bracket extending from the casing and having an internal thread by which the bracket might be supported by a tripod.

Preferably, the internal thread is metallic and the camera support further comprises a base to support the bracket on a support surface, the base having an embedded magnet to attract the internal thread without the need for threaded engagement between the base and bracket.

Preferably, the base comprises a concave cover and the bracket comprises a convex riding surface of profile complementary to the cover, wherein a magnetic field between the embedded magnet and the metallic thread maintains contact between the bracket and the base sufficient to retain the camera in a desired position.

Preferably, the bracket is detachable from the casing.

As used herein the word “camera” is intended to encompass digital cameras and mobile devices such as telephones incorporating a lens and also all digital video cameras and recorders, tablets and mobile devices (including tablets) that incorporate a lens for picture and video taking.

### BRIEF DESCRIPTION OF THE DRAWINGS

A preferred form of the present invention will now be described by way of example with reference to the accompanying drawings, wherein:

FIG. 1 is a schematic parts-exploded perspective illustration of a camera adapter and base, and an Apple iPhone®;

FIG. 2 is a schematic perspective cross-sectional illustration of the adapter; and

FIG. 3 is a schematic perspective illustration of the adapter and base.

### DETAILED DESCRIPTION

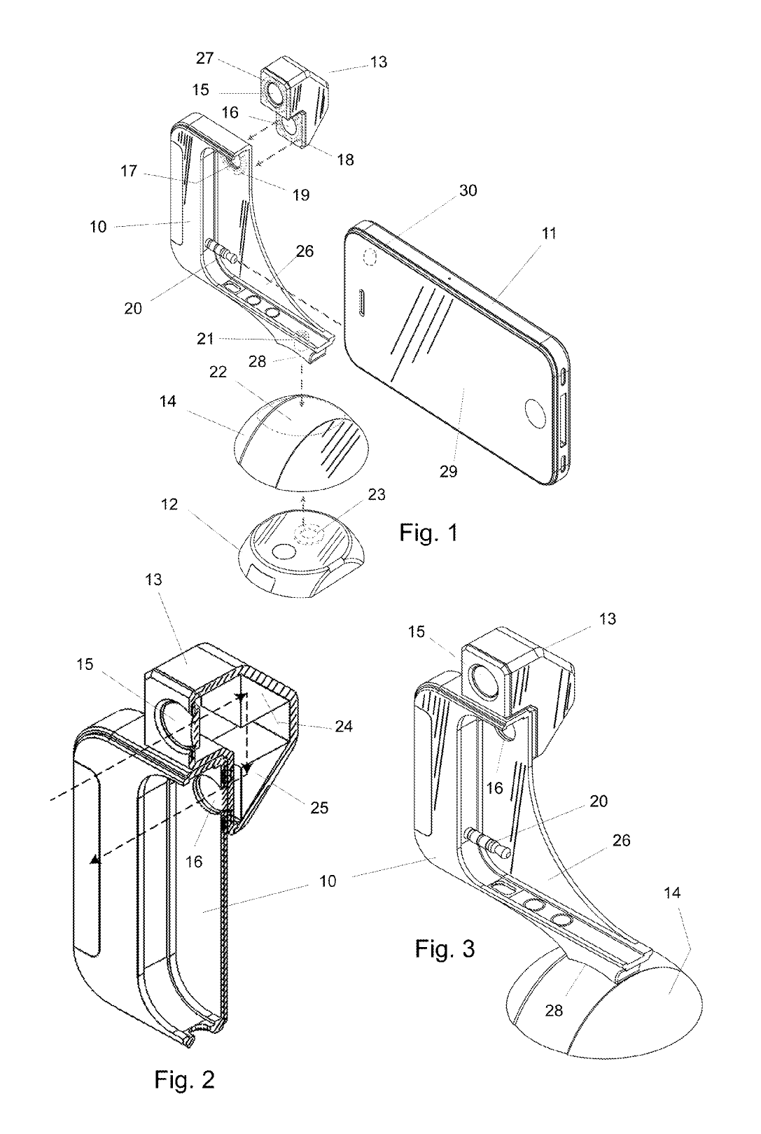

In the accompanying drawings there is depicted schematically a casing 10 to receive the edge portion of an Apple iPhone® which is shown at 11 in FIG. 1 in an orientation in which its display screen 29 would be facing the photographic subject. It should be appreciated however that the invention can be adapted to any brand of digital camera whether incorporated into a mobile telephone or otherwise.

The casing 10 is typically formed of moulded plastics material and houses an infrared or RF receiver typically of 2.4 GHz (not shown) or any other wireless transmission technology (including Bluetooth). The casing 10 is somewhat in the form of a cradle into which a portion of the camera is received. The internal surface of the casing 10 could have a soft inlay say of silicone or rubber to prevent damage or scratching of the inserted iPhone or camera. A miniature plug 20 (typically a 3.5 mm plug) extends from the casing and aligns with a corresponding “earphone” socket provided in the iPhone 11. Trigger signals received by the infrared or RF receiver are passed via the plug to the camera 11 in order that photographs be taken.

The casing 10 includes an aperture 17 that aligns with the good-quality lens 30 at the back of the iPhone. Surrounding the aperture 17 and embedded into the plastics moulding is a metallic ring 19 typically made of ferrous or otherwise magnetically attractive material. As an alternative, the ring 19 could itself be a magnet.

A body 13 somewhat in the form of a periscope comprises internal mirrors 24 and 25. The mirrors are oriented generally at 45°, but at 90° with respect to one another. The lower mirror 25 has in front of it an aperture 16 surrounded by a magnetic anchor ring 18. The body 13 is typically formed of moulded plastics material and the anchor ring 18 would be moulded into the plastic. The magnetic anchor 18 attaches the body 13 to the casing 10 by magnetic interaction with the metal ring 19.

At the top of the body 13, there is provided a top lens 15 surrounded by a metallic ring 27. The metallic ring 27 would be embedded in the moulded plastics material of the body. The purpose of this ring is to attach optional auxiliary lenses such as wide-angle, fisheye, macro, zoom, or telephoto lenses having a magnetic anchor similar to anchor 18. As indicated by the dotted lines in FIG. 2, light from a subject passing through the lens 15 reflects off the mirror 24 to the mirror 25 off which the light reflects into the good lens of the iPhone 11.

A bracket 26 extends from the casing 10. It can be formed integrally with or attached to the casing 10. The bracket 26 includes a metallic insert 21 having an internal thread. This would be of standard size to engage with the thread of a third party tripod for example. Accordingly, the casing 10 can be fixed in a variety of orientations to support the iPhone 11 as desired. A concave surface 28 is provided below the thread insert 21.

A base 12 is provided with a metallic insert 23. A concave base cover 14 has a large embedded magnet 22 by which the cover 14 is retained upon the base 12 by interaction with the metallic insert 23. The profile of the cover 14 corresponds with that of the concave surface 28 and the large magnet 22 also attracts the threaded metallic insert 23 of the bracket 26 throughout a range of movement so that the casing 10 and supported iPhone 11 can be oriented as desired. The mating surfaces are adapted to ride smoothly upon one another, but have sufficient friction in combination with a magnetic attraction to retain the parts in a fixed orientation.

In typical use, the user can remotely take self-portrait pictures via the front view camera on the phone. This remote feature therefore improves upon the previous method of taking self-portrait pictures limited by one's arm as the maximum possible length for such an application. It also allows all the people in a party/event/function to be included in the photograph. It also eliminates the need for enlisting 3rd parties to hold the phone to take pictures.

The transmission distance of the IR or 2.4 GHz transmitter/remote control unit is typically about 5 meters.

The 180° extractable lens body 13 (with internal mirrors and lens refraction and reflection capacity) that is clamped onto the casing 10 allows the photographer to use the high resolution and high definition camera on the back of the iPhone instead of the low resolution front lens to take pictures of the people. At the same time, the people, the subject of the image can view the image display screen 29 on the iPhone 11 to achieve sharp, crisp, high quality pictures.

The under-section of the half-sphere shaped base 12 can store the IR and/or 2.4 GHz transmitter/remote control unit for portability and to prevent loss.

The IR and/or 2.4 GHZ transmitter/remote control unit can be powered by a button cell battery (included or not included).

The IR and/or 2.4 GHz receiver would typically draw power directly from the iPhone unit via the plug 20 and does not necessarily require additional battery power, but nevertheless, an additional button cell could be provided within the casing 10.

The unit typically draws powers and is used and its functions applied through the 3.5 mm earphone jack on the iPhone, but the 30 pin charger connector on the bottom of the phone could also be used for its entire application and purpose.

The IR/2.4 GHz transmitter/receiver would typically have two buttons/keys (namely + and −). Pressing the + key will allow the user to take pictures. Pressing the − key will allow the user to take videos. These functions will be carried via an App written and designed specifically for this purpose.

Optional magnetic (based on North/South polarity) fisheye lenses, wide angle lenses, macro lenses, zoom lenses can be bundled together with the body 13 to enable a variety of pictures enhancing fun and creativity.

It should be appreciated that modifications and alterations obvious to those skilled in the art are not to be considered as beyond the scope of the present invention. For example, rather than providing mirrors 24 and 25, these features could be replaced by optical prisms, lenses and/or prism/lens/mirror combinations. Also, rather than providing metallic rings at the body 13 and casing 10, these could be replaced by additional magnets ensuring correct north-south polarity to ensure attraction between the adjoining parts.

Furthermore, the body 13 could be formed integrally with the casing 10 rather than being detachable.

1. An adapter for a camera having an image display screen at one side thereof and a lens at another side thereof, the adapter comprising:
a body;
attachment means for attaching the body to the camera;
optical means supported by the body to reflect and/or refract light into the lens from a subject viewing the image display screen directly.

2. The adapter of claim 1, wherein said optical means comprises:
a first optical means to align with the camera lens when the body is so attached; and
a second optical means aligning with the subject and cooperating with the first optical means.

3. The adapter of claim 1, wherein the first and second optical means comprise mirrors cooperating with one another to reflect light from the subject throughout 180° to the camera lens.

4. The adapter of claim 3, wherein the mirrors are mutually offset by 90°.

5. The adapter of claim 3, further comprising a top lens through which light from the subject must pass en route to the mirrors.

6. The adapter of claim 5, wherein the body further comprising a magnetic or metallic ring around the top lens to magnetically secure an auxiliary lens such as a fisheye lens.

7. The adapter of claim 1, wherein said attachment means for attaching the body to the camera comprises:
a magnetic or metallic anchor at the body;
a casing to receive a portion of a camera, the casing comprising an aperture to align with the camera lens, and a metallic or magnetic attractant to which the anchor attaches magnetically to maintain said alignment.

8. The adapter of claim 7, wherein the casing comprises an internal thread by which the casing might be supported by a tripod.

9. The adapter of claim 8, wherein the internal thread is metallic and the adapter further comprises a base to support the casing on a surface, the base having an embedded magnet to attract the internal thread without the need for threaded engagement between the base and casing.

10. The adapter of claim 7, wherein the casing comprises an electrical plug that is received by a jack of the camera when the casing receives a portion of the camera, the casing housing an infrared or RF receiver to receive remotely controlled camera activation signals passed to the camera via the plug.

11. A camera support, comprising:
a casing to receive a portion of a camera, the casing comprises an electrical plug that is received by a socket of the camera; and
an infrared or RF receiver to receive remotely controlled trigger signals to control the camera via the plug.

12. The camera support of claim 11, further comprising a bracket extending from the casing and having an internal thread by which the bracket might be supported by a tripod.

13. The camera support of claim 12, wherein the internal thread is metallic and the camera support further comprises a base to support the bracket on a support surface, the base having an embedded magnet to attract the internal thread without the need for threaded engagement between the base and bracket.

14. The camera support of claim 13, wherein the base comprises a concave cover and the bracket comprises a convex riding surface of profile complementary to the cover, wherein a magnetic field between the embedded magnet and the metallic thread maintains contact between the bracket and the base sufficient to retain the camera in a desired position.

15. The camera support of claim 13, wherein the bracket is detachable from the casing.
